(19) United States
(12) Patent Application Publication
(10) Pub. No.: US 2017/0238757 A1
(43) Pub. Date: Aug. 24, 2017

(54) MICROWAVE COOKWARE

(71) Applicant: ZOOMWORKS LLC, Minnetonka, MN (US)

(72) Inventors: Charles M. Hengel, Woodland, MN (US); Kerry D. Mullen, Shorewood, MN (US)

(21) Appl. No.: 15/237,838

(22) Filed: Aug. 16, 2016

Related U.S. Application Data
(60) Provisional application No. 62/298,553, filed on Feb. 23, 2016.

(51) Int. Cl. A47J 36/02; A47J 27/13; H05B 6/64; A47J 27/00

(52) U.S. Cl. CPC A47J 36/027; A47J 27/002; A47J 27/13; H05B 6/6494

(57) ABSTRACT

The present description provides a cooking instrument that may be used in a microwave oven. In some embodiments, the cooking instrument includes a body member having a cooking surface and a microwave absorptive layer thermally connected to the cooking surface.

### TECHNICAL FIELD

This document describes devices, systems and methods for cooking food items, and in some embodiments, stackable cookware having a cooking surface and a microwave absorptive layer for cooking food items in a microwave oven.

### BACKGROUND

Various devices for containing food items while cooking in a microwave oven are well known. In some circumstances, containers have been proposed that include a microwave absorptive layer, for example, directly in contact with the food item. The microwave absorptive layer may convert electromagnetic energy into heat to promote cooking of the food items.

### SUMMARY

In general, this document describes devices, systems and methods for cooking food items, for example, in a microwave oven. Exemplary cooking instruments may include a metallic cooking plate (having an exposed cooking surface) and a microwave absorptive layer that can heat the metallic cooking plate when subjected to electromagnetic energy, such as electromagnetic energy from a microwave oven. Such devices may enhance microwave cooking of food items by allowing multiple modes of heating, and may result in a grilled texture, appearance, and/or flavor. Optionally, the microwave absorptive layer can be fixed to an underside of the metallic cooking plate (or otherwise positioned oppositely from the exposed cooking surface) so that the microwave absorptive layer generates heat for transmission to the metallic cooking plate via, for example, heat conduction.

For example, some embodiments described herein provide a microwavable cooking instrument including a first metallic plate having a cooking surface and a first microwave absorptive layer. A microwave permeable body may at least partially surround the first metallic plate and first microwave absorptive layer. The cooking instrument may include a second metallic plate having a cooking surface and a second microwave absorptive layer. The first metallic plate may be positionable below the food item, while the second metallic plate may be positionable above a food item, for example. The cooking instrument may include one or more additional metallic plates and microwave absorptive layers that can be arranged in a stackable configuration. Multiple food items may be positioned between respective metallic plates and cooked simultaneously.

Particular embodiments described herein may include a microwave absorptive layer applied to a metallic plate by a high temperature binder. The high temperature binder securely affixes the microwave absorptive layer in thermal connection with the metallic plate, and resists degradation from exposure to electromagnetic energy, water, oils, soaps, and fats, for example. Additionally or alternatively, the high temperature binder securely bonds together components of the microwave absorptive layer in a generally fixed position relative to one another, including one or more susceptor materials (described in more detail below) or other components of the microwave absorptive layer.

Some embodiments of the devices, systems and methods described herein may provide one or more of the following advantages. First, cooking instruments described herein can provide convenient, effective and easy-to-use instruments for cooking food items in a microwave oven that may enhance the flavor, texture, and/or appearance of the food items. Microwave absorptive layers affixed in thermal connection with a metallic plate promotes conductive and/or radiant cooking of food items, and may simulate the effect of a barbeque grill. Second, cooking instruments including multiple metallic plates and/or microwave absorptive layers can generate heat above and below a food item, promoting consistent and thorough cooking of a food item without requiring excessive manipulation by a user. Third, affixing a microwave absorptive layer with a high temperature binder results in a durable cooking instrument that can cook food items at high temperatures for a sufficient duration, and may resist degradation from microwave energy, water, oils, soaps, fats, etc. Fourth, a cooking instrument that includes one or more stackable components provides a modular cooking system that can accommodate a user's preferences and a variety of food types. Fifth, a cooking instrument including a component having multiple metallic plates may allow simultaneous cooking of two or more food items. For example, a cooking instrument including a body member having an upper and lower metallic plate may be used to cook a first food item supported on the upper metallic plate and a second food item positioned below the lower metallic plate. Further, a single layer of microwave absorptive layer may be positioned between, and transfer heat to, each of the first and second metallic plates.

The details of one or more embodiments are set forth in the accompanying drawings and the description below. Other features and advantages will be apparent from the description and drawings, and from the claims.

### DESCRIPTION OF DRAWINGS

The present description is further provided with reference to the appended Figures, wherein like structure is referred to be like numerals throughout the several views, and wherein:

FIG. 1 is a perspective view of an exemplary cooking instrument in a stacked configuration.

FIG. 2 is an exploded perspective view of the exemplary cooking instrument of FIG. 1.

FIG. 3 is an exploded cross-sectional view of an exemplary cooking instrument.

FIG. 4 is a cross-sectional view of a body member of an exemplary cooking instrument.

FIG. 5 is a perspective view of an exemplary cooking instrument in a stacked configuration.

FIG. 6 is an exploded perspective view of the exemplary cooking instrument of FIG. 5.

FIG. 7 is a perspective view of an exemplary cooking instrument in a closed configuration.

FIG. 8 is a perspective view of the exemplary cooking instrument of FIG. 7 in an open configuration.

FIG. 9 is a perspective view of an exemplary cooking instrument in a closed configuration.

FIG. 10 is a perspective view of the exemplary cooking instrument of FIG. 9 in an open configuration.

FIG. 11 is a perspective view of an exemplary cooking instrument in a closed configuration.

FIG. 12 is a perspective view of the exemplary cooking instrument of FIG. 11 in an open configuration.

### DETAILED DESCRIPTION OF ILLUSTRATIVE EMBODIMENTS

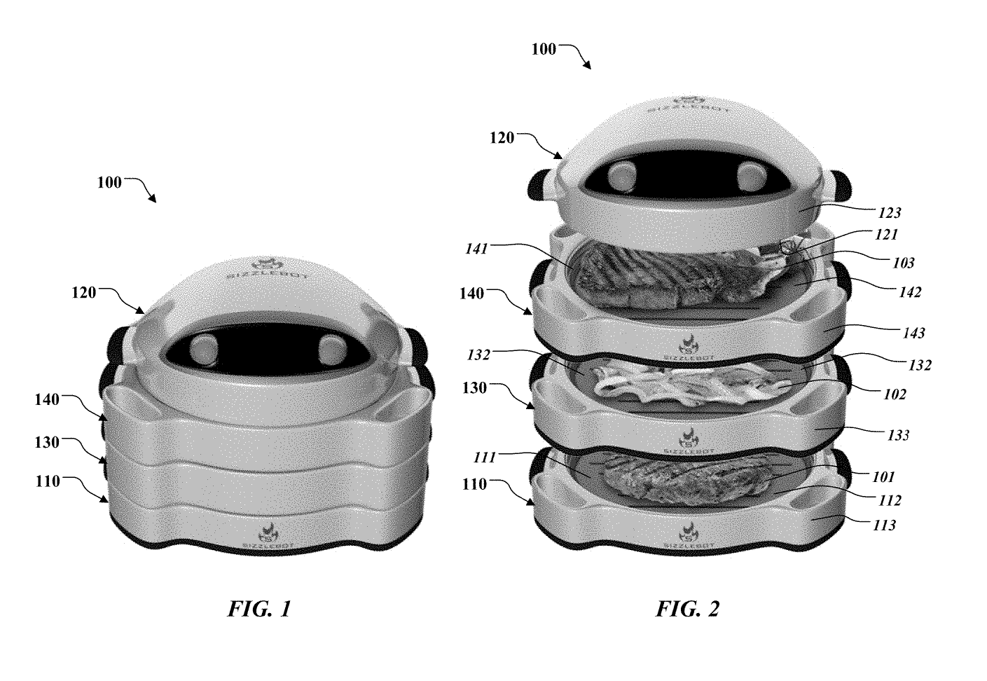

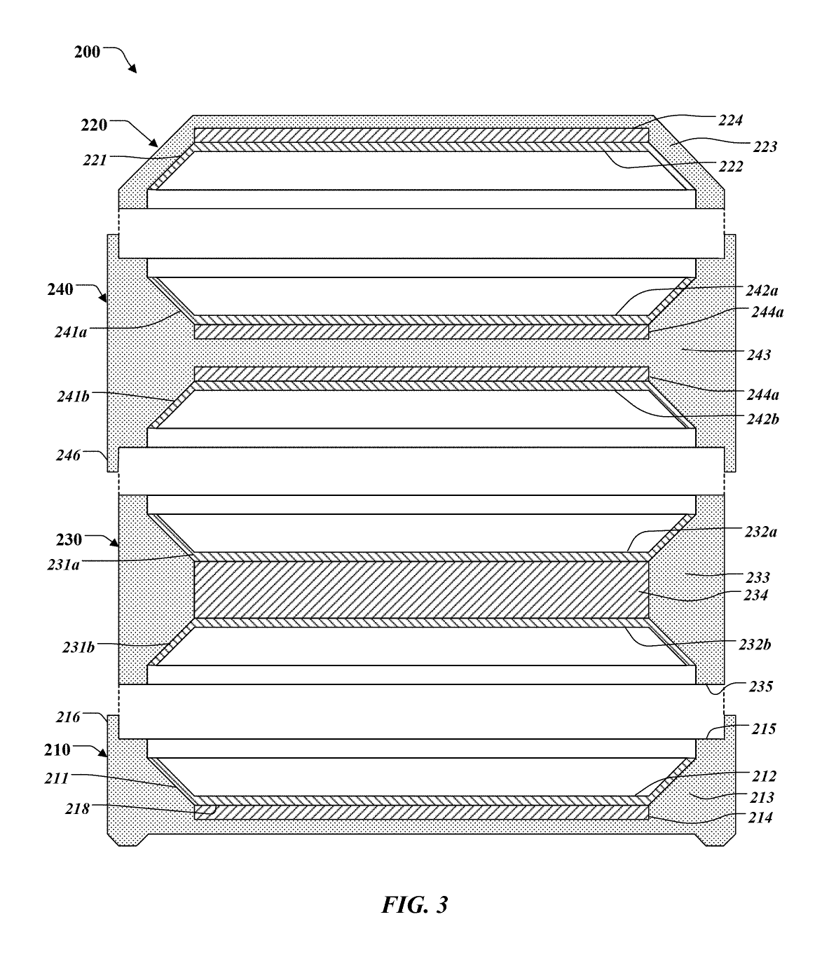

Referring to FIGS. 1 and 2, an exemplary cooking instrument 100 is shown that includes a lower body member 110 having a metallic plate 111, a cooking surface 112 and a microwave absorptive layer (FIG. 3) thermally connected to metallic plate 111. The microwave absorptive layer emits heat when subjected to electromagnetic energy in a microwave oven. Heat is transferred to metallic plate 111 to promote cooking of one or more food items positioned on cooking surface 112 of metallic plate 111.

First metallic plate 111 includes a cooking surface 112 and an opposite major surface. Metallic plate 111 includes a thermally conductive material such that metallic plate 111 conducts heat from the microwave absorptive layer to cooking surface 112 during cooking. For example, metallic plate 111 may include a thin metallic plate, such as a thin aluminum plate. Alternatively or additionally, metallic plate may include steel, stainless steel, tin, or copper, for example. Cooking surface 112 is configured for contact with one or more food items during use, and may include one or more coating layers. For example, cooking surface 112 may include a fluoropolymer layer, such as a polytetrafluoroethylene material that provides a substantially non-stick coating layer. Alternatively or additionally, cooking surface 112 may include a ceramic, silicone, enamel, or an anodized surface, such as anodized aluminum, for example. In some optional embodiments, the cooking plates described herein (e.g., plate 111 and others described herein) may comprise little or no metallic material, and may instead comprise, for example, a ceramic material, a thermally conductive plastic material, or a combination thereof that is configured to conduct sufficient heat to the cooking surface 112 for purposes of cooking the food item.

Microwave permeable layer 113 includes a microwave permeable material that allows transmission of microwave energy to a microwave absorptive layer. For example, microwave permeable layer 113 is sufficiently permeable to allow microwave radiation to reach the microwave absorptive layer and cause the microwave absorptive layer to rapidly heat. In an exemplary embodiment, microwave permeable layer 113 includes a thermally insulative material so that an outer surface of body member 110 remains relatively cooler for handling by a user. Microwave permeable layer 113 may include a high-temperature polymer than can withstand heat generated by the microwave absorptive layer. In various exemplary embodiments, microwave permeable material 113 may include polyethylene terephthalate, crystallizable polyethylene terephthalate, ethylene tetrafluoroethylene, high-density polyethylenes, low-density polyethylenes, polypropylenes, polycarbonates, polysulfones, polyaryletherketones, perflouroalkoxy fluorocarbon resins, fluorinated ethylene propylenes, silicones, high-temperature thermosets, high-temperature thermoplastics, polyamides, glasses, porcelains, rubbers, or ceramics, for example. First body member 110 may include multiple layers or portions of microwave permeable materials 113. For example, an inner first microwave permeable material may be present at an inner location of first body member 110, and an outer microwave permeable material may be present at an exterior location to provide a desired aesthetic appearance.

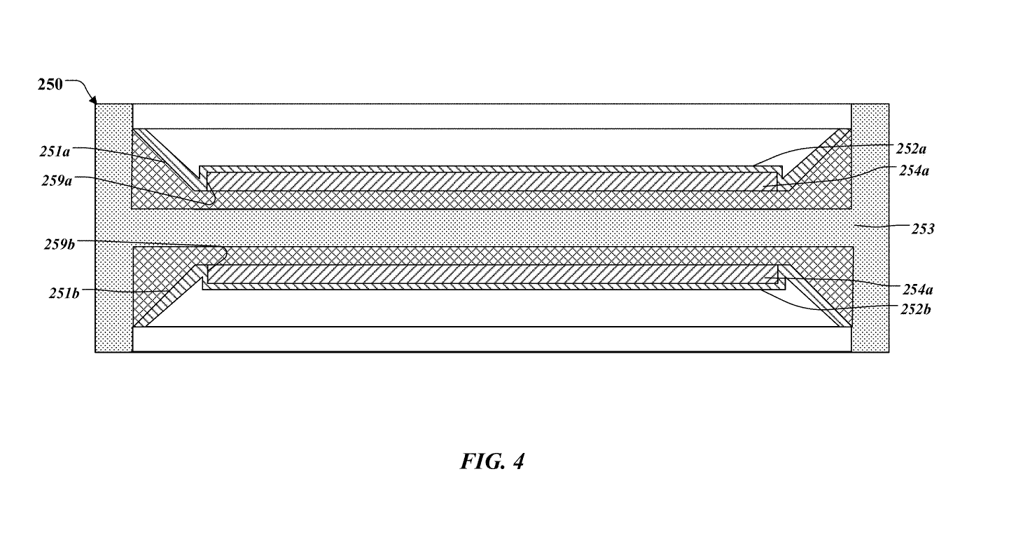

A microwave absorptive layer (concealed from view in FIGS. 1-2, as shown for example in FIGS. 3-4) is positioned in thermal connection with metallic plate 111. For example, the microwave absorptive layer can be positioned in thermal connection with the metallic plate so that it efficiently transmits heat energy to the metallic plate 111, including for instance, being directly joined with a region of metallic plate 111. The microwave absorptive layer is configured to absorb electromagnetic energy, for example, emitted by a microwave oven, and rapidly converts the electromagnetic energy to heat. Microwave absorptive layer may include one or more susceptor materials, such as one or more metals, semimetals, metallized films, ceramics or other microwave absorptive layer, for example. In an exemplary embodiment, microwave absorptive layer includes graphite in a powdered or flaked form. Alternatively or additionally, microwave absorptive layer may include carbide, silicon carbide, titanium carbide, zirconium carbide, molybdenum carbide, boride, titanium boride, zirconium boride, calcium boride, nitride, silicone nitride, zirconium nitride, molybdenum, steel, iron silicate, magnetite, ferrite cobalt oxide, manganese dioxide, copper oxide, carbon, combinations thereof, and/or other materials that emit heat when subjected to electromagnetic radiation.

The microwave absorptive layer has an appropriate weight percentage of microwave absorptive content, such as graphite or other susceptor material, sufficient to generate heat when exposed to electromagnetic radiation in a microwave oven, such as a microwave oven having a wattage in the range of about 800 Watts to about 1,200 Watts, and preferably about 1100 Watts in particular embodiments. In various exemplary embodiments, microwave absorptive layer affixed to metallic plate 111 has a weight percentage of one or more susceptor materials between 10% and 98%, 20% and 90%, 30% and 80%, or about 40%, and for example may be greater than 15%, 20%, 25%, 30%, 35%, 40%, 45%, 50%, 55%, 60%, 65%, 70%, 75%, 80%, or greater than 80% by weight of graphite or other susceptor material.

The microwave absorptive layer may include one or more susceptor materials embedded in a resin material. For example, graphite and/or other susceptor components may be carried in a high-temperature resin material bonded to a component of cooking instrument 100, such as an interior surface of metallic plate 111. In an exemplary embodiment, the microwave absorptive layer, including the high-temperature resin material (preferably, having the susceptor components mixed therein), is deposited directly to metallic plate 111 in a non-solid or viscous form (e.g., a liquid form) and thereby bonded directly to a targeted region of the metallic plate 111. The microwave absorptive layer may be permanently affixed to metallic plate 111, or other portions of cooking instrument 100, by electrostatic bonding, catalytic bonding, and/or heat or ultraviolet curing, for example.

The microwave absorptive layer, and/or a resin or binder material of the microwave absorptive layer, resists degradation from exposure to heat, electromagnetic energy, water, oils, soaps, and fats, for example, and may rapidly reach temperatures between about 200° F. to 800° F. when exposed to electromagnetic radiation in a microwave oven. In various exemplary embodiments, the microwave absorptive layer, and/or a resin or binder material of the microwave absorptive layer, is hydrophobic. Such materials promote a durable cooking instrument 100 that may withstand repeated use under conditions typically encountered in microwave cooking, and that may be safe for use in automatic dishwashers to promote easy cleaning.

In an exemplary embodiment, microwave absorptive layer is formed from a dispersion including a resin binder, a susceptor component, and a solvent. To form a body member of cooking instrument 100 including a microwave absorptive layer, the dispersion is coated on metallic plate 111 and dried. The coated dispersion may be heated to an elevated temperature to facilitate drying and/or curing, and to provide a robust bonding with metallic plate 111 or another component of body member 110. In some exemplary embodiments, one or more components may evaporate such that the resulting microwave absorptive layer is porous, and may exhibit a relatively low bulk density. In various exemplary embodiments, the dispersion may contain between 5% and 75%, 10% and 50%, or about 28% by weight of the resin binder, 10% and 80%, 20% and 60%, or about 45% by weight of the susceptor component, such as graphite, and between 15% and 75%, 25% and 50%, or about 38% by weight of the solvent.

In other exemplary embodiments, microwave absorptive layer is formed from a mixture including a resin binder and susceptor component. The mixture may be coated on metallic plate 111 and pressed at an elevated temperature to bind the mixture to metallic plate 111.

In various exemplary embodiments, a binder of the microwave absorptive layer may include a thermoset polymer, thermoplastic polymer, silicone, polyepoxides, ceramic, polyester, styrene, polyethylene, acrylonitrile butadiene styrene, polyaryletherketone, polyether etherketone, polyetherimide, polyphenylene sulfide, polysulfone, polyethylene, polymethylmethacrylate, polyethylene terephthalate, cellulose acetate, fluoropolymer, polytetrafluoroethylene, ethylene propylene diene, polyester, polyamide, polyamide-imide, polypropylene, polyurethane, polyphenylene oxide, polycarbonate, polyphenylene ether, polyisocyanate, clays, moullonite, vermiculite, hectorite, silica, sodium silicate, soda ash, combinations thereof, and/or other binder materials. One or more solvents may be incorporated that facilitate application and curing of the microwave absorptive layer, such as a ketone, acetone, cyclopentanone, ethyl isopropyl ketone, isophorone, mesityl oxide, methyl isopropyl ketone, methyl ethyl ketone, pentanone, and combinations thereof, for example.

Cooking instrument 100 may include an appropriate number of body members each including one or more cooking surfaces. For example, cooking instrument 100 may include two, three, four, five, six, or more than six body members. A cooking instrument having between 2 and 4 body members may facilitate varied cooking configurations while being readily accommodated by typical microwave ovens and compact for easy storage. For example, cooking instrument 100 may include one or more additional body members that each include one or more metallic cooking plates, microwave absorptive layers, and/or microwave permeable materials that at least partially surround the microwave absorptive layer and metallic cooking plates. For example, cooking instrument 100 includes an upper body member 120 including a second metallic plate 121, a second microwave absorptive layer, and a second microwave permeable material 123 that surrounds upper and side portions of second metallic plate 121. Second microwave permeable material 123 at least partially encases the microwave absorptive layer between second microwave permeable material 123 and second metallic plate 121. First cooking surface 112 of first metallic plate 111 is configured to be oriented upward to cook a food item positioned on cooking surface 114, and the second cooking surface of second metallic plate 121 is configured to be oriented downward to cook a food item positioned below the second cooking surface.

One or more intermediate body members, such as third and fourth body members 130, 140, may be positioned between lower and upper body members 110, 120 to provide additional cooking spaces that may accommodate food items separately from a food item positioned between lower body member 110 and third body member 130. Third and/or fourth body member 130, 140 may each include multiple cooking surfaces. For example, third body member 130 includes top metallic plate 131 and top cooking surface 132, a bottom metallic plate and a bottom cooking surface (not shown in FIGS. 1-2), microwave permeable material 133, and one or more microwave absorptive layers. In an exemplary embodiment, the first and second metallic plates are thermally connected to a single microwave absorptive layer and/or may be provided by a unitary metallic component.

Body members of cooking instrument 100, such as body members 110, 120, 130, and 140, for example, provide a modular and configurable cooking instrument 100. Body members 110, 120, 130, and 140 are stackable, and may be mixed and matched to provide a desired cooking configuration. For example, lower and upper body members 110, 120 may be stacked without third and fourth body members 130, 140 to cook a single food item in contact between cooking surface 112 of lower body member 110 and a cooking surface of upper body member 120. Similarly, third and/or fourth body members 130, 140 may be stacked between lower and upper body members 110, 120 to allow simultaneous cooking of additional food items in a stacked configuration.

Body members 110, 120, 130, and 140 include one or more complementary mating surfaces to facilitate stacking. For example, lower body member 110 may include one or more complementary surfaces 115 that another body member, such as third body member 130, may rest on. Complementary surfaces 115 may allow respective body members to at least partially nest relative to one another in a stacked configuration, and may provide a relatively compact configuration for storage (FIG. 1).

Cooking instrument 100 may thus allow a user to adjust cooking instrument 100 between a compact configuration (FIG. 1), for storage or for cooking relatively thin items, for example, and an expanded configuration in which large food items may be accommodated. In an expanded configuration, respective body members may be spaced by one or more complementary features or by at least partial support on a food item positioned between the respective body members. For example, body members may include one or more complementary features that provide a predetermined spacing between respective cooking surfaces. An outer rim of lower body member 110 may contact an outer rim of third body member 130 such that a predetermined spacing is provided between cooking surface 112 and the lower cooking surface of third body member 130. The predetermined spacing may provide a minimum spacing when lower body member 110 and third body member 130 are stacked with no food items present, and the spacing between cooking surface 112 and the lower cooking surface of third body member 130 may be larger when cooking surface 132 contacts a food item such that third body member 130 rests on, and is at least partially supported by, the food item. Alternatively or in addition, body members of cooking instrument 100 may include one or more complementary features that allow a variable spacing between respective cooking surfaces configured to promote contact with a food item.

In use, a first food item 101 may be positioned between cooking surface 112 of first body member 110 and a bottom cooking surface of third body member 130, a second food item 102 may be positioned between a top cooking surface 132 of third body member 130 and a bottom cooking surface of fourth body member 140, and a third food item 103 may be positioned between top cooking surface 142 of fourth body member 140 and a cooking surface of upper body member 120. Cooking instrument 100, containing food items 101, 102, and 103 may be positioned in a microwave oven. The user may then operate microwave oven to deliver electromagnetic energy. Microwave absorptive layers of cooking instrument 100 rapidly generate heat that is transferred to respective cooking surfaces and food items 101, 102, 103. Cooking instrument 100 facilitates conductive and radiant heat transfer to the food items, enhancing the flavor, texture, and/or appearance of the food items.

Referring to FIG. 3, an exploded, cross-sectional view of an exemplary cooking instrument 200 is shown. Cooking instrument 200 includes stackable body elements, and in some embodiments may be similar to cooking instrument 100 described above. Cooking instrument 200 includes a lower body member 210 having a cooking plate 211, cooking surface 212, microwave permeable material 213 and microwave absorptive layer 214, and an upper body member 220 having a cooking plate 221, cooking surface 222, microwave permeable material 223 and microwave absorptive layer 224. One or more intermediate body members, such as third body member 230 and fourth body member 240, may be positioned between lower and upper body members 210, 220 in a stacked configuration.

Intermediate body members 230, 240, may include multiple cooking surfaces. For example, third body member 230 includes top and bottom metallic plates 231a, 231b having a top cooking surface 232a and a bottom cooking surface 232b, microwave permeable material 233, and one or more microwave absorptive layers 234. In an exemplary embodiment, first and second metallic plates 231a, 231b are thermally connected to a single microwave absorptive layer 234, such that a single microwave absorptive layer 234 heats top and bottom cooking surfaces 232a, 232b, that are spaced from one another. In other exemplary embodiments, two or more separate microwave absorptive layers may be provided in thermal connection with top and bottom metallic plates 231a, 231b, respectively, and may be separated by one or more other materials, such as microwave permeable layer 233. Top and bottom metallic plates 231, 231b may be separate components, or may be a unitary metallic component that is folded, molded, or otherwise shaped to provide top and bottom cooking surfaces 232a, 232b.

Fourth body member 240 may similarly include top and bottom metallic plates 241a, 241b having a top and bottom cooking surfaces 242a, 242b, microwave permeable material 243, and one or more microwave absorptive layers 234. In an exemplary embodiment, first and second microwave absorptive layers 244a, 244b, are thermally connected to top and bottom metallic plates 241a, 241b, respectively. First microwave absorptive layer 244a may be spaced a desired distance from second microwave absorptive layer 244b by microwave permeable material 243. Microwave permeable material 243 may promote consistent microwave absorption across an entire area of first and second microwave absorptive layers. In some exemplary embodiments, a distance separating first and second microwave absorptive layers 244a, 244b, may be greater than a thickness of the microwave absorptive layers 244a, 244b. Such a configuration may promote consistent heat generation and heat transfer to metallic plates 241a, 241b. In other exemplary embodiments, first and second metallic plates 241a, 241b may be thermally connected to a single microwave absorptive layer, such that a single microwave absorptive layer heats top and bottom cooking surfaces 242a, 242b that are spaced from one another.

Body members 210, 220, 230, and 240 of cooking instrument 200 are stackable in a vertical arrangement configurable by a user. Body members 210, 220, 230, and 240 include one or more complementary mating features to facilitate stacking of respective body members. For example, lower body member 210 includes a mating surface 215 that may be in contact with a complementary mating surface 235 of third body member 230 when third body member 230 is stacked on lower body member 210. Interference between complementary mating surfaces 215, 235, may provide a predetermined minimum spacing between cooking surfaces 214 and 234b when third body member 230 is stacked on lower body member 210.

Alternatively or in addition, lower body member 210 may include a flange 216 at least partially defining a space that third body member 230 may be positioned in when stacked on lower body member 210. For example, third body member 230 may be received at least partially within the space such that an outer surface of third body member 230 is positioned adjacent to an inner surface of flange 216. Third body member 230 may thus be at least partially nestable within lower body member 210. Further, a spacing between cooking surface 212 of lower body member 210 and cooking surface 232b of third body member 230 may be variable while third body member 230 is nested in lower body member 230. For example, third body member 230 may be at least partially in contact with, and/or supported on, a food item positioned on cooking surface 212, while contact between flange 216 and an outer surface of third body member 230 promotes stability to retain third body member 230 in a stacked configuration above lower body member 210.

In various exemplary embodiments, lower body member 210 and/or third body member 230 may include one or more other complementary mating features, such as one or more surfaces, flanges, protrusions, snap-fits, or keyed openings, for example. Upper body member 220 and/or fourth body member 240 may similarly include one or more complementary mating features to facilitate stacking or respective body members, and can include one or more surfaces, flanges, protrusions, snap-fits, or keyed openings, for example.

In some exemplary embodiments, the spacing of respective cooking surfaces may be variable by changing the sequence and/or relationship of stacked body members. For example, a user may stack third body member 230 in a nested relationship on lower body member 210 to provide a first spacing between cooking surface 212 and cooking surface 232b. Alternatively, a user may stack fourth body member 240 on lower body member 210 to provide a second spacing, different from the first spacing, between cooking surface 212 and cooking surface 242b. For example, fourth body member 240 may include flanges 246 that contacts flanges 216 of lower body member 216 to provide a relatively larger spacing between cooking surface 212 and cooking surface 242b. Accordingly, a user can select a desired configuration for particular food items by adjusting a stacking sequence of one or more body members of cooking instrument 200. Alternatively or in addition, a spacing or configuration may be adjustable by rotating one or more body members, about a vertical longitudinal axis, for example, to cause a post and slot, or other complementary features to either be in alignment (e.g. to provide a relatively smaller spacing between respective cooking surfaces) or out of alignment (e.g. to provide a relatively greater spacing). Similarly, one or more body members may be asymmetrical, or include different mating features on top and bottom sides, such that the body member may be flipped to provide a desired configuration.

Similarly, spacing between respective body members may be variable by changing the sequence and/or relationship of stacked body members to allow desired air circulation or venting. For example, in a first configuration, relatively less venting may be provided between body members, and in a second configuration, relatively more venting may be provided between body members, due to interaction between one or more surfaces, flanges, protrusions, snap-fits, or keyed openings, for example.

The microwave absorptive layers of cooking instrument 200 are arranged in proximity with respective metallic plates of one or more body members such that generated heat is readily transferred to the metallic plate and exposed cooking surface. Microwave absorptive layer 214 of lower body member 210 is positioned adjacent to an interior major surface 218 of metallic plate 211 in close proximity with metallic plate 211. Interior major surface 218 may be a surface opposite cooking surface 212 such that microwave absorptive layer remains out of contact with food items on cooking surface 212.

In an exemplary embodiment, microwave absorptive layer 214 is directly bonded to metallic plate 211, similar to cooking instrument 100, describe above, and is present over the entire interior major surface 218. A metallic plate having an entire interior major surface 218 positioned adjacent microwave absorptive layer 214 promotes even heating and consistent cooking. In other exemplary embodiments, microwave absorptive layer 214 may be present at selected locations to affect heat distribution of metallic plate 214. For example, microwave absorptive layer 214 may be omitted or provided in a reduced thickness and/or quantity to provide a relatively lower temperature area, and may be included or provided with a greater thickness and/or quantity to provide a relatively higher temperature area. Non-uniform positioning of microwave absorptive layer may be configured to promote “grill lines” having a particular pattern on food items prepared with cooking instrument 200, for example.

In an exemplary embodiment, a metallic plate of an exemplary cooking instrument may be shaped to accommodate microwave absorptive layer. Referring to FIG. 4, an exemplary body member 250 is shown including a recess 259 defined by metallic plate 251. A microwave absorptive layer 254 is positioned at least partially within recess 259. Microwave absorptive layer 254 may be at least partially surrounded on multiple sides by metallic plate 251, promoting rapid heat transfer from microwave absorptive layer 254 to metallic plate 251, and to cooking surface 252 and a food item proximate cooking surface 252.

Alternatively or in addition, a thickness of metallic plate 251 and microwave absorptive layer 254 may be configured to promote rapid heat generation and transfer. For example, metallic plate 251 has a material thickness between cooking surface 252 and interior major surface 259 that is less than a thickness of microwave absorptive layer 254. A relatively thin metallic plate 251 allows close proximity between cooking surface 252 and microwave absorptive layer 254, and may promote rapid heat transfer from microwave absorptive layer 254 to cooking surface 252, and to a food item proximate cooking surface 252. Alternatively or in addition, recess 259 may have a depth that is greater than a material thickness of metallic plate 251.

An exemplary cooking instrument including one or more body members, such as body member 250, may be made by assembling a metallic plate, a microwave permeable material, and microwave absorptive layer. In one example, a microwave absorptive layer, such as a liquid or powder comprising a binder, susceptor component, and/or solvent, is positioned in recess 259 in contact with metallic plate 251. The liquid or powder is dried and/or cured by exposure to heat, air, pressure or ultraviolet radiation, for example, sufficient for the liquid or powder to become securely affixed to metallic plate 251 within recess 259. One or more microwave permeable materials 253 may be then be applied to metallic plate 251. For example, microwave permeable material 253 may be molded to metallic plate 253, such as in an overmolding process and/or joined with mechanical or adhesive techniques, for example.

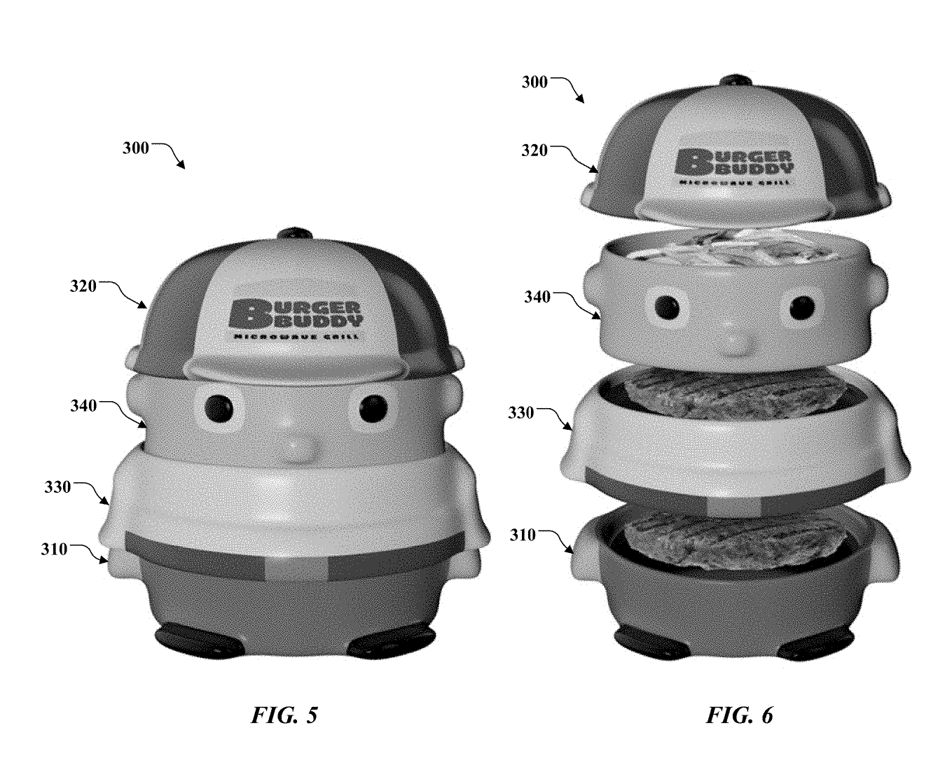

Referring to FIGS. 5 and 6, an exemplary cooking instrument 300 is shown. Cooking instrument 300 includes multiple stackable body elements, and in some embodiments may include one or more features similar to cooking instrument 200 described above. Cooking instrument 300 includes lower and upper body members 310, 320, and intermediate body members 330, 340. Each body member may include one or more metallic plates, microwave absorptive layers, and microwave permeable materials.

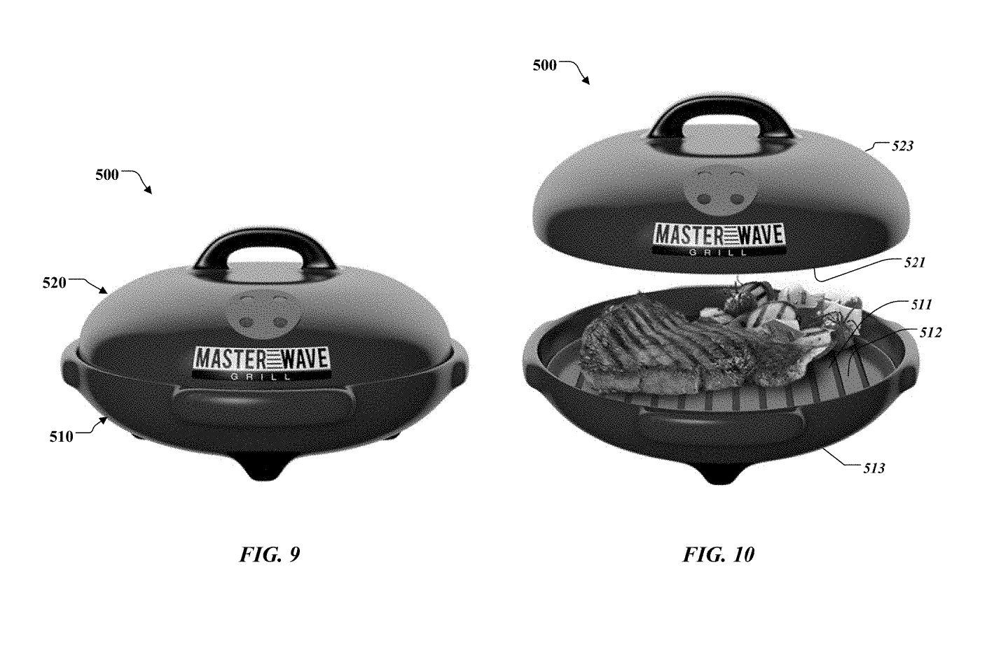

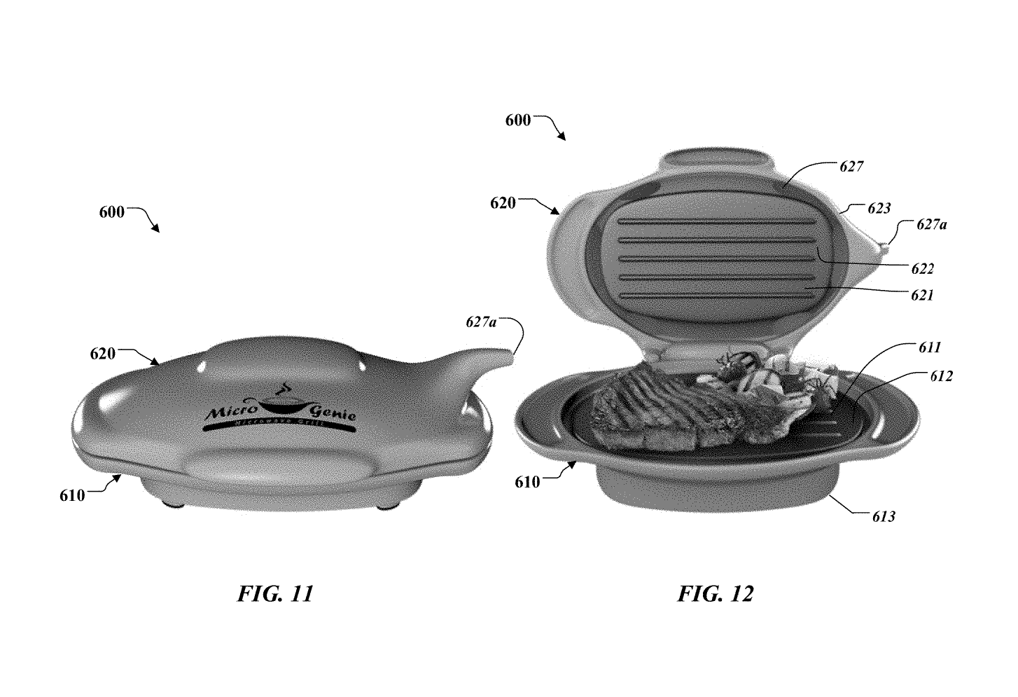

Body members 310, 320, 330, and 340 are configured to provide a desired aesthetic appearance in a stacked configuration. Each body member may have a desired appearance or features that form a portion of an overall appearance of cooking instrument 300. In an exemplary embodiment, cooking instrument 300 has an appearance of an anthropomorphic character. Each body member has the appearance of a portion of the character, and may be stacked to complete the appearance of the character. For example, lower body member 310 is shaped in the form of feet and/or legs, intermediate body member 330 is shaped in the form of a torso, intermediate body member 340 is shaped in the form of a face and/or head, and upper body member 320 is shaped in the form of a cap. Cooking instrument 300 providing the appearance of an anthropomorphic character or unique object may facilitate intuitive stacking of respective body members and provide an entertaining cooking experience. In various exemplary embodiments, an exemplary cooking instrument may have the appearance of a robot (FIG. 1), barbeque grill (FIGS. 9 and 10), genie's lamp (FIGS. 11 and 12) or other character or object, such as a car or building, for example.

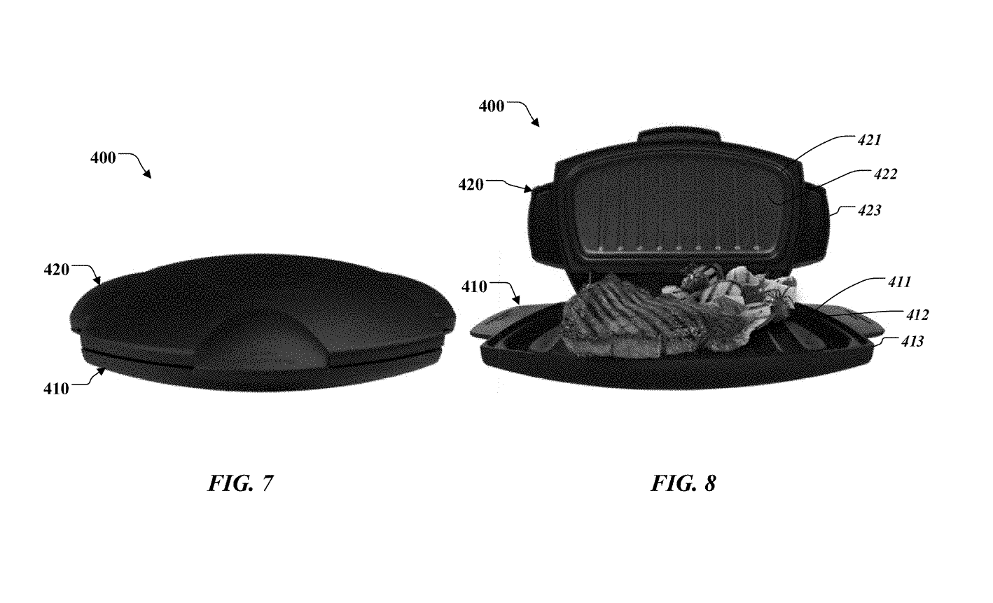

Referring to FIGS. 7 and 8, an exemplary cooking instrument 400 is shown, including body elements that are hingedly connected, and in some embodiments may include one or more features similar to cooking instrument 300 described above. Lower body member 410 includes a metallic plate 411, cooking surface 412, microwave permeable material 413, and a microwave absorptive layer (not shown in FIGS. 7 and 8) positioned between metallic plate 411 and microwave permeable material 413. Upper body member 420 may similarly include a metallic plate 421, cooking surface 422, microwave permeable material 423, and a microwave absorptive layer (not shown in FIGS. 7 and 8) positioned between metallic plate 421 and microwave permeable material 423.

Upper and lower body members 410, 420 are hingedly connected such that upper body member 420 may pivot relative to lower body member 410. For example, to prepare a food item 401, a user may pivot upper body member 420 into an open configuration, position food item 401 on metallic plate 411, pivot upper body member 420 to a closed configuration onto food item 401, and subject cooking instrument 400 and food item 401 to electromagnetic energy in a microwave oven. Microwave absorptive layers of lower and upper body members convert the electromagnetic energy to heat that is transferred to metallic plates 411, 421, and to food item 401 positioned between the metallic plates 411, 421.

In some exemplary embodiments, a cooking instrument may have the appearance of a barbeque grill. Referring to FIGS. 9 and 10, an exemplary cooking instrument 500 is shown that may be perceived as having an appearance similar to a barbeque grill, such as a charcoal grill, and may include one or more features similar to cooking instrument 400 described above. In an exemplary embodiment, cooking instrument 500 includes a lower body member 510 having the appearance of a lower grill portion, and upper body member 520 having the appearance of a lid or upper grill portion.

Exemplary cooking instruments may provide a desired amount of airflow or venting proximate cooking surfaces of the cooking instrument. Referring to FIGS. 11 and 12, an exemplary cooking instrument 600 is shown having a lower body member 610, an upper body member 620, and in some embodiments may include features similar to cooking instrument 500 described above. Cooking instrument 600 includes features that promote desirable venting or airflow between metallic cooking plates 611 and 621. For example, upper body member 620 includes one or more venting apertures through and/or around metallic plate 621 leading to a cavity 627. Cavity 627 is defined by one or more components of upper body member 620, such as microwave permeable material 623, and provides a space for steam, etc., generated during cooking, to pass into. In an exemplary embodiment, cavity 627 is substantially closed along its upper surface, and does not include vents or other openings to the external environment. Alternatively, upper body member 620 may define one or more vents 627a extending between cavity 627 and an external environment.

In an exemplary embodiment, cooking instrument 600 may have the appearance of a “genie's lamp.” A user's perception of cooking instrument 600 as a “genie's lamp” may be enhanced by a vent 627a extending through a nozzle or spout 629 of upper body member 620. Immediately after preparing a food item in cooking instrument 600, visible steam may flow out of vent 627a.

Lower and upper body members 610, 620, and/or components of lower and upper body members 610, 620 may be removably attachable from each other. For example, metallic plates 611, 621 may be removably attachable with other portions of lower and upper body members 610, 620. Removable metallic plates 611, 621 may facilitate easy cleaning of metallic plates 611, 621, cavity 627, and/or other components of cooking instrument 600.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A microwavable cooking instrument, comprising:
a first body member having a first cooking surface, a first microwave absorptive layer that emits heat when subjected to electromagnetic radiation and that is thermally connected with the first cooking surface, and a first microwave permeable layer at least partially surrounding the first cooking surface and the first microwave absorptive layer;
a second body member having a second cooking surface, a second microwave absorptive layer that emits heat when subjected to electromagnetic radiation and that is thermally connected with the second cooking surface, and a second microwave permeable layer at least partially surrounding the second cooking surface and the second microwave absorptive layer;
wherein the first body member is stackable with the second body member.

2. The microwavable cooking instrument of claim 1, wherein the first cooking surface comprises a first metallic plate having a first exposed cooking surface, and the second cooking surface comprises a second metallic plate having a second exposed cooking surface.

3. The microwavable cooking instrument of claim 2, wherein the first microwave absorptive layer is positioned on an opposite side of the first cooking surface from the first exposed cooking surface, and the second microwave absorptive layer is positioned on an opposite side of the second cooking surface from the second exposed cooking surface.

4. The microwavable cooking instrument of claim 3, wherein the first microwave absorptive layer comprises a susceptor material embedded in a binder adhered to the first metallic plate, and the second microwave absorptive layer comprises a susceptor material embedded in a binder adhered to the second metallic plate.

5. The microwavable cooking instrument of claim 4, wherein the first and second microwave absorptive layers have thicknesses greater than the first and second metallic plates.

6. The microwaveable cooking instrument of claim 4, wherein the first microwave absorptive layer comprises graphite embedded in a resin binder bonded directly to the first metallic plate, and the second microwave absorptive layer comprises graphite embedded in a resin binder bonded directly to the second metallic plate.

7. The microwaveable cooking instrument of claim 5, wherein the first and second microwave absorptive layers are hydrophobic.

8. The microwavable cooking instrument of claim 1, wherein the first exposed cooking surface is configured to face upwards during use and the second exposed cooking surface is configured to face downwards during use.

9. The microwavable cooking instrument of claim 1, further comprising a third body member including a third metallic plate having a third exposed cooking surface, a third microwave absorptive layer that emits heat when subjected to electromagnetic radiation and that is thermally connected with the third metallic plate, and a third microwave permeable layer at least partially surrounding the third metallic plate and the third microwave absorptive layer, wherein the third body member is stackable with the first and second body members.

10. The microwavable cooking instrument of claim 9, wherein the third body member comprises a fourth metallic plate having a fourth exposed cooking surface, and wherein the third exposed cooking surface is configured to face upwards during use and the fourth exposed cooking surface is configured to face downwards during use.

11. The microwavable cooking instrument of claim 10, wherein the third microwave absorptive layer is positioned between the third and fourth metallic plates and is thermally connected to both of the third and fourth metallic plates.

12. The microwavable cooking instrument of claim 8, wherein the first body member comprises a first mating feature and the second body member comprises a second mating feature, and the first and second mating features are directly engageable with each other such that the first body member is stackable with the second body member.

13. The microwavable cooking instrument of claim 12, wherein the third body member comprises third and fourth mating features engageable with the first and second mating features such that the third body member is stackable between the first and second body members.

14. The microwavable cooking instrument of claim 13, wherein the first, second, and third body members have the appearance of an anthropomorphic character in a stacked configuration.

15. A method of making a microwave cooking instrument, comprising:
forming a first body member by applying a dispersion comprising a resin binder, a susceptor, and a solvent to a first metallic plate having a first exposed cooking surface, and bonding the dispersion to the first metallic plate to form a first microwave absorptive layer thermally connected to the first metallic plate;
forming a second body member by applying a dispersion comprising a resin binder, a susceptor, and a solvent to a second metallic plate having a first exposed cooking surface, and bonding the dispersion to the second metallic plate to form a second microwave absorptive layer thermally connected to the second metallic plate;
wherein the first body member comprises a first microwave permeable layer at least partially surrounding the first metallic plate and the first microwave absorptive layer, and the second body member comprises a second microwave permeable layer at least partially surrounding the second metallic plate and the second microwave absorptive layer.

16. The method of claim 15, wherein the first metallic plate comprises a recess on an opposite side of the first metallic plate from the first exposed cooking surface, and the resin binder, susceptor, and solvent are applied to the recess.

17. The method of claim 16, wherein the dispersion comprises between 10% and 50% by weight of the resin binder, between 20% and 60% by weight of the susceptor, and between 25% and 50% by weight of the solvent.

18. The method of claim 16, comprising forming a third body member by applying a dispersion comprising a resin binder, a susceptor, and a solvent to a third metallic plate having a third exposed cooking surface, and bonding the dispersion to the third metallic plate to form a third microwave absorptive layer thermally connected to the third metallic plate, wherein the third body member further comprises a fourth metallic plate thermally connected to the third microwave absorptive layer, and a microwave permeable layer at least partially surrounding the third and fourth metallic plates.

19. The method of claim 18, wherein the third body member is stackable with the first and second body members.

20. The method of claim 19, wherein the fourth metallic plate comprises a fourth exposed cooking surface, the third exposed cooking surface configured to face upwards during use and the fourth exposed cooking surface configured to face downwards during use.
